(19) United States
(12) Patent Application Publication
(10) Pub. No.: US 2009/0150213 A1
(43) Pub. Date: Jun. 11, 2009

(54) Method and system for providing customizable market analysis

(75) Inventors: Peter Andrew Cyr, Chevy Chase, MD (US); Richard Wieland, Redding, CT (US)

Correspondence Address: DITTHAVONG MORI & STEINER, P.C., 918 Prince St., Alexandria, VA, 22314, US

(73) Assignee: Documental Solutions, LLC., Falls Church, VA (US)

(21) Appl. No.: 12/000,241

(22) Filed: Dec. 11, 2007

(51) Int. Cl. G06F 17/00

(52) U.S. Cl. 705/10

(57) ABSTRACT

An approach is disclosed for providing segmented market forecasts. A query is received from a user via a graphical user interface. Market analysis information is retrieved from a data repository in response to the query, wherein the market analysis information includes forecast data about a product and associated components in relation to a plurality of market segments, the data being hierarchically arranged with respect to the components. The market analysis information is presented to the user via the graphical user interface.

### BACKGROUND INFORMATION

Companies and organizations providing products and/or services to customers continually seek to achieve a competitive advantage in the marketplace. One way businesses achieve competitive advantages is by analyzing marketplace dynamics to generate market-based intelligence information. Market intelligence information can be used for purposes, such as business development, strategic planning, competitive intelligence, merger and acquisition analysis, teaming analysis, and executive support, as well as many other suitable business related purposes. Accordingly, businesses spend billions of dollars a year on market research; however, due to the increasing amount of information, that market research is growing increasingly more complex and convoluted.

Therefore, there is a need for an approach for efficiently and effectively aggregating and analyzing market data, as well as delivering meaningful marketplace intelligence.

### DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing segmented market forecasts, according to an exemplary embodiment;

FIG. 2 is a diagram of an application server capable of providing a segmented market forecast, according to an exemplary embodiment;

FIGS. 3A and 3B are flowcharts of a process for generating a segmented market forecast based on market analysis information and a process for generating and presenting segmented market analysis information, according to various exemplary embodiments;

FIGS. 4A and 4B are diagrams of user interfaces utilized in the processes of FIGS. 3A and 3B, according to various exemplary embodiments;

FIG. 5 is a diagram illustrating the process of generating segmented market analysis information, according to an exemplary embodiment;

FIGS. 6A-6C are diagrams of segmented market analysis reports, according to various exemplary embodiments; and

FIG. 7 is a diagram of a computer system that can be used to implement various exemplary embodiments.

### DETAILED DESCRIPTION OF THE PREFERRED EMBODIMENT

An apparatus, method, and software for providing segmented market forecasts are described. In the following description, for the purposes of explanation, numerous specific details are set forth in order to provide a thorough understanding of the various exemplary embodiments. It is apparent, however, to one skilled in the art that the various exemplary embodiments may be practiced without these specific details or with an equivalent arrangement. In other instances, well-known structures and devices are shown in block diagram form in order to avoid unnecessarily obscuring the exemplary embodiments.

Although the various exemplary embodiments are described with respect to particular industries (e.g., aerospace and defense) and related products/services markets, it is contemplated that these embodiments have applicability to market data in general, encompassing a host of industries, such as the advertisement industry, construction industry, consumer electronics industry, manufacturing industry, oil and gas industry, pharmaceutical industry, software industry, telecommunication industry, textiles industry, transportation industry, etc.

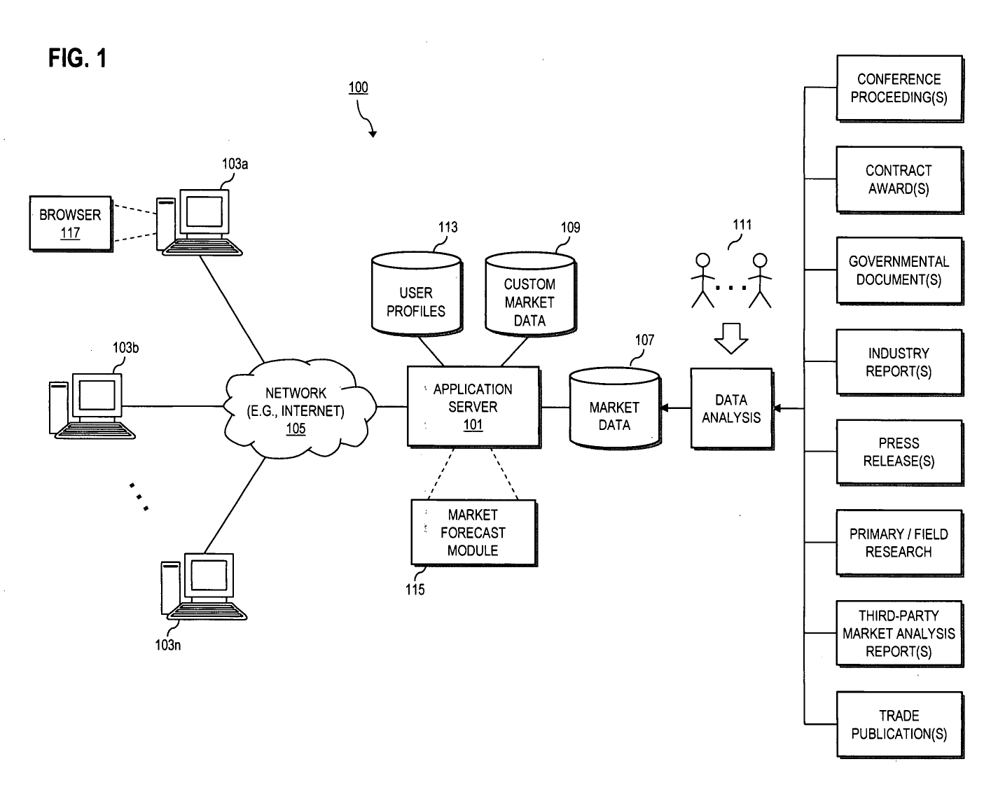

FIG. 1 is a diagram of a system capable of providing segmented market forecasts, according to an exemplary embodiment. For the purposes of illustration, a system 100 is described with respect to a distributed client/server architecture. While specific reference will be made thereto, it is to be appreciated that embodiments of system 100 may be provided having other computing architectures and/or environments, e.g., a peer-to-peer architecture or a master/slave framework.

It is noted that modern economic landscapes are being shaped by at least two overriding market forces, e.g., synergistic technological innovation and globalization. These forces are, in turn, causing the amount of information to increase at unprecedented rates. While a vast array of data is available, the volume of information is generating new problems. Namely, the data sources themselves provide varying and duplicative metrics (e.g., sample sizes, population, etc.), as well as conflicting results. As such, businesses attempting to gain a competitive edge through the use of knowledge-based market analysis, are becoming excessively burdened by the onerous task of gathering, aggregating, integrating, and analyzing the vast array of data sources, not to mention stifled by the possibilities that certain aspects are being overemphasized or other details are being overlooked. This inevitably leads to information overload, wherein a business is “data rich” but “information poor.” That is, the value of the data becomes lost in the details. Little attention has been afforded to extending and enhancing the value-adding capabilities of market analysis information. Therefore, it is apparent that improvements are needed.

Accordingly, various embodiments of system 100 provide extensive market analysis information, but at the same time, provide interactive, customizable ways to segment (or otherwise granulate) this data into manageable, information rich reports. In one embodiment, system 100 introduces a market research and forecast service whereby users are provided access to a centralized source of market analysis information, e.g., aggregated market data concerning various customers, competitors, and one or more product and/or service markets, to facilitate individualized market research. Other embodiments of system 100 enable users to augment, customize, and/or modify a particular set of market analysis information to further enhance the overall dataset and, thereby, the individualized market research obtained therefrom.

In this manner, certain implementations of system 100 enable users to formulate one or more customizable reports via, for instance, a web-based charting interface or any other suitable graphical user interface (GUI), utilizing the market analysis information or an individualized dataset thereof. According to one embodiment, the interface is configured to facilitate the assessment of one or more markets and/or market segments. Such market segments may involve predetermined data divisions (e.g., geographic divisions, product/service divisions, product/service component divisions, supplier/customer divisions, customer divisions, etc., as well as combinations thereof) related to a particular target market population. These customizable reports may include historical market perspectives and/or market forecasting information corresponding to a target product/service and associated product/service components, as well as the product/service and associated product/service component suppliers and/or customers. According to other embodiments, the customizable reports may be further generated based on one or more market criteria specifying a market definition (e.g., scope, type, and/or geography), as well as a market view (e.g., market segment, analysis methodology, forecasting methodology, and/or segmentation methodology). Namely, users may generate and modify, in substantially real-time, one or more customizable reports comprising historical analysis of existing market data and/or market predictions based on various marketplace dynamics, such as estimated product deliveries, forecasted revenues, market trends, boundary forces (e.g., governmental regulations), existing inventories, emerging technologies, buying patterns, existing/emerging competitors, etc. In other instances, the market analysis information may be correlated and/or referenced to particular documentation, analyst assessment, or combinations thereof. In other words, the market research and forecast service of system 100, according to certain embodiments, stems from the recognition that businesses can benefit from efficient, convenient access to comprehensive market intelligence provided they are able to seamlessly granulate the data to obtain customizable reports based on individualized market definitions, as well as augment, customize, and/or modify the market intelligence. Thus, according to certain embodiments, system 100 provides the market research and forecast service through easily manipulated, intuitive interfaces, such as an online GUI provided through a browser application, having a variety of options for viewing market analysis information. According to other embodiments, the interfaces of system 100 provide access to (and use of) various repositories including gathered, aggregated, integrated, and analyzed market data, as well as analysis, insight, and consulting information related to that data.

As shown, system 100 includes an application server 101 accessible to one or more client devices 103a-103n via, for example, a network 105. By way of example, client devices 103a-103n, upon which various embodiments can be executed, include, any computing device capable of sending and receiving data. For instance, client-devices 103a-103n may comprise a desktop computer, notebook computer, server, terminal workstation, multi-processor system, microprocessor-based or programmable consumer electronic device, minicomputer, mainframe computer, customized hardware, or other equivalent apparatus, such as a personal digital assistant (PDA), pocket personal computer, smart phone, tablet, handset, and the like. In turn, network 105 may be an external network, such as the Internet or other wide area network (WAN), or an internal network, such as a virtual private network (VPN) or other local area network (LAN). It is further contemplated that network 105 may comprise any public or private network capable of data transmission, such as a data network, telephony network, wireless network, and the like, as well as any suitable combination thereof. As such, network 105 enables client devices 103a-103n to seamlessly access application server 101 to implement the market research and forecast service of system 100. In addition to passing data, network 105 may also pass emails, facsimiles, and other electronic communications and/or information transfers between application server 101 and client devices 103a-103n, such as for providing market research and analysis reports in alternative or additional formats. Further, application server 101 may access, as well as provide access to, one or more repositories, such as one or more databases 107, 109, and 113.

Databases 107 and 109 provide centralized storage for various forms of market analysis information relating to one or more product and/or service markets. This information may be static or dynamic. Namely, databases 107 and 109 are configured to be continuously and/or periodically updated with the most current market analysis information. It is noted that market analysis information generally makes known the size and value (i.e., quantitative magnitude) of different commodities of a target market; however, this information may be presented through various schemes and formats (i.e., quantitative and/or qualitative comparisons). At a basic level, market analysis information may include market power and/or financial data relating to information, such as best quotations, last sale data, product/component prices, award contracts, annual revenues, aggregate market valuations, competitor market share, saturation levels (e.g., number of units manufactured, sold, shipped, imported, etc.), scheduled and/or projected contract bids (e.g., a measure of customer demand), and the like. This information may be gleaned from a systematic review, collation, and/or synthesis of various periodicals or other informational sources including, but certainly not limited to, conference proceeding(s), contract award(s), governmental document(s), industry report(s), press release(s), and trade publication(s), as well as any other suitable medium, such as third-party market research report(s), etc. In other instances, the market analysis information may be generated based on the recording and analyzing of customer, competitor, and/or market data gathered through consumer panels, experiments, focus groups, interviews, observations, surveys, test marketing, and the like. That is, the market analysis information may correspond to secondary (or desk) research, as well as primary (or field) research. According to one embodiment, one or more market analysts 111 gather, aggregate, integrate, and analyze these information sources to extract, reconcile, and generate (when necessary) market analysis information, which is then stored in (or to) database 107. In other implementations, this process of acquiring and developing market analysis information may be performed by application server 101 or an “expert” system (not shown) via any suitable data mining and/or synthesis technique. Furthermore, the market analysis information may be additionally correlated and/or referenced to the information source(s) and/or market analyst 111 assessment(s) from which it was extracted, reconciled, and/or generated.

Database 109 may also provide centralized storage for market analysis information; however, the data stored therein may be profiled or correspond to one or more users such that the users can also utilize user customized datasets for the assessment of one or more markets and/or market segments. That is, database 109 may provide virtualized storage for select users. In this manner, the select users may be permitted to download and/or modify the market analysis information of database 107, wherein those users may also be permitted to store a modified dataset to database 109 or any other suitable repository (not illustrated) of system 100, such as a user-controlled or third-party-controlled repository accessible over, for instance, network 105. In one embodiment, select users may also be permitted to create and/or upload their own market intelligence, which may also be stored to database 109 or any other suitable repository of system 100. These user-provided datasets may be correlated to the market analysis information of database 107. A user profiles database 113 may be provided for maintaining authentication (or authorization) information, user access rights, and one or more parameters governing the utilization of user customized datasets, as well as any other suitable user profile information, such as user defined policies for the presentation of a GUI, the display of market research/forecast reports, or importing/exporting market analysis information, etc. While illustrated as separate entities, one or more of databases 107, 109, and 113 may be combined, provided by a database server (not shown) or management system (not illustrated), and/or collocated at application server 101, as well as made accessible over network 105 and/or any other suitable network (not shown), such as a network of a provider of the market research and forecast service.

According to one embodiment, the market analysis information is hierarchically arranged within databases 107 and/or 109 with respect to one or more criteria. The arrangement may, for example, correspond to a “top-down” structure, i.e., one or more datasets may be defined and then populated with one or more data elements, or a “bottom-up” structure, i.e., one or more data elements may be defined and then logically grouped to form one or more datasets. The criteria may, for instance, correspond to one or more market characteristics (e.g., suppliers, customers, geographies, and the like) and/or one or more (sub)product(s)/(sub)service(s) of a market. As such, databases 107 and/or 109 may be multi-dimensional, analytical processing, and/or any other suitable database for storing market analysis information. In a database management system; data is stored in one or more data containers, each container contains records, and the data within each record is organized into one or more fields. In relational database systems, the data containers are referred to as tables, the records are referred to as rows, and the fields are referred to as columns. Relational databases enable datasets to be organized and accessed according to relationships between data elements, such as common market characteristics or product platform. In object-oriented databases, the data containers are referred to as object classes, the records are referred to as objects, and the fields are referred to as attributes. Object-oriented databases enable datasets to be organized and accessed as an entirety, such as a complete dataset of market analysis information corresponding to an industry. It is contemplated that other database architectures may utilized and may refer to other terminology. As such, the particular semantics used to describe various exemplary embodiments are merely illustrative and are not intended to limit the nature or structure of the repositories or other data stores of system 100.

Communication between databases 107, 109, and/or 113 and application server 101 may be accomplished by way of one or more application programming interfaces (API) supporting one or more query languages, such as common query language (CQL), extensible markup language (XML) path language, object query language (OQL), and/or structured query language (SQL), as well as any other suitable method. According to one embodiment, data stored in databases 107, 109, and/or 113 is structured or compartmentalized into fields and tables. For example, market analysis information may be stored on databases 107 and/or 109 having a data structure including columns and rows corresponding to particular data fields and data entries, respectively, that further correspond to a hierarchical categorization of the market analysis information.

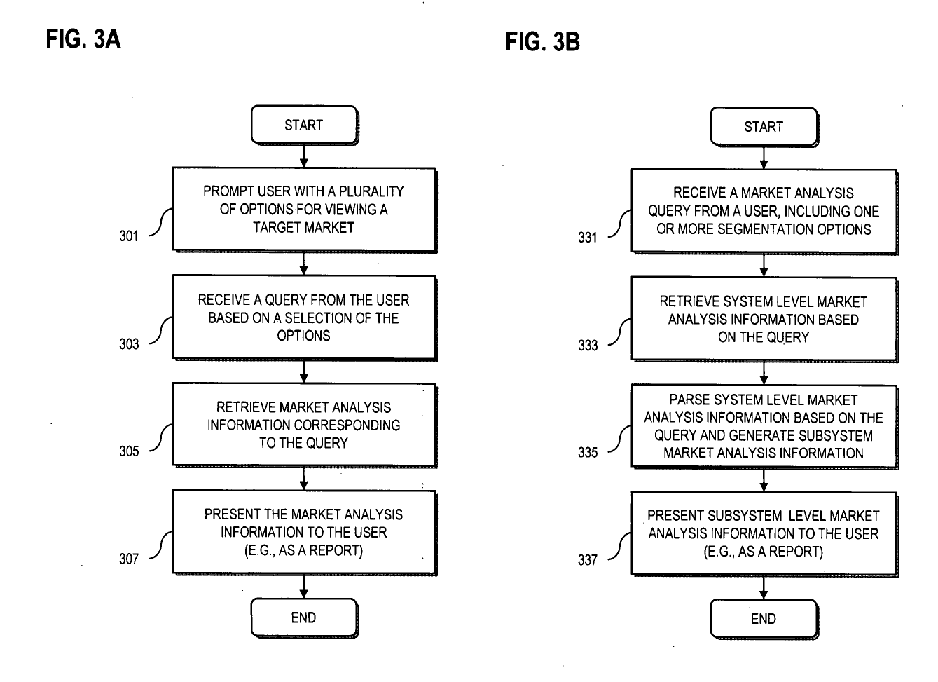

By way of example, particular columns at a product/service (system) level may correspond to categories, such as hierarchical identification, product/service identification, product/service supplier, product/service platform name, sub-products/sub-services included within the product/service platform and level of integration or contribution, target customer(s), and target geographic market(s), as well as include various financial aspects related to the product/service, such as product/service supplier percentage of the market(s), product/service supplier percentage of the market(s) as a function of geography or customer(s), annual revenue for a predetermined number of years, etc. In turn, particular columns at a sub-product/sub-service (subsystem) level may correspond to categories, such as hierarchical identification, sub-product/sub-service identification, sub-product/sub-service supplier, the product/service platform(s) that the sub-product/sub-service is integrated into, the level of integration into or contribution to a particular platform(s), target customer(s), target platform supplier(s), and target geographic market(s), as well as correspond to financial aspects related to the sub-product/sub-service, such as a sub-product/sub-service supplier percentage of the market(s), a sub-product/sub-service supplier percentage of the market(s) as a function of customer(s), geography, or platform provider(s), an associated percentage of the annual revenue for a predetermined number of years relating to an overall product/service platform, etc. In particular implementations, databases 107 and/or 109 may simply provide the product/service level market analysis information and application server 101 is further configured to parse the product/service level data for particular information (e.g., sub-products/sub-services included within the product/service platform and corresponding level of integration) and, utilizing this information, generate sub-product/sub-service market analysis information. This process is explained in greater detail in conjunction with FIG. 3B.

According to other embodiments, the market analysis information may be hierarchically coordinated into a “data cloud” to avoid redundant entries, which may increase the data harnessing capabilities of databases 107 and 109. It is noted, however, that the aforementioned data structures are merely exemplary and are not intended to limit the nature or structure of databases 107 and 109. Nevertheless, the hierarchical nature of the information stored in, on, or to databases 107 and 109 enables users to analyze and interface with underlying market analysis information at any level of granularity.

As such, the market analysis information may correspond to various product or service industries, such as the aerospace and defense industries; however, it is contemplated that embodiments of system 100 may be extended into any product/service market, as previously mentioned. For illustrative purposes, the market analysis information (corresponding to the aerospace and defense industries) may relate to complex markets and systems—e.g., the air and missile defense markets, the anti-submarine warfare market, the command and control systems markets, the commercial aircraft market, the electronic warfare market, the electro-optical infrared system market, the guns and ammunition markets, the homeland security markets, the ISR (intelligence, surveillance, and reconnaissance) systems markets, the military aircraft market, the military communication systems market, the military ships market, the military vehicles market, the missile systems market, the precision guided weapon systems market, the radar systems market, the spacecraft market, the unmanned systems markets, and the like, as well as the various services and consumables markets associated with the aforementioned product markets.

In this manner, application server 101 includes a market forecast module 115 configured to facilitate a user's ability to obtain the market analysis information concerning one or more product and/or service markets. According to one embodiment, market forecast module 115 is functionally driven by coded instructions, commands, and/or other business logic/rules for deploying the market research and forecast service of system 100. Namely, through a graphical user interface (GUI), market forecast module 115 provides users with “high” level access (e.g., through one or more menus of options) to the market intelligence information of databases 107 and 109. This access may be further provided in readily understandable formats, such as visual reports (e.g., tables, graphs, charts, written text, etc.) that condense the abundance of existing information residing in the aforementioned information sources into manageable quantities.

According to particular implementations, an “online” GUI may be provided through a conventional browser application 117 executed on (or by) a computing device, such as client device 103a. Such an interface provides users ubiquitous access to efficient tools that enable the users to manipulate one or more menus of options for substantially instantaneous viewing of desired market analysis information concerning a user-defined target market for a product/service within a requested reporting format, as well as readily obtain new reports or modify an existing report to “drill down” into the underlying information. Additionally, market forecast module 115 can provide users access to analyst generated opportunities derived from the existing market analysis information, or may, itself, analyze the data to generate emerging market requirements. According to one implementation, this forecast information may be weighed by probabilistic evaluations, which assess the expected value of a predicted scenario. This enables market forecast module 115 to appraise business opportunities without overstating a market.

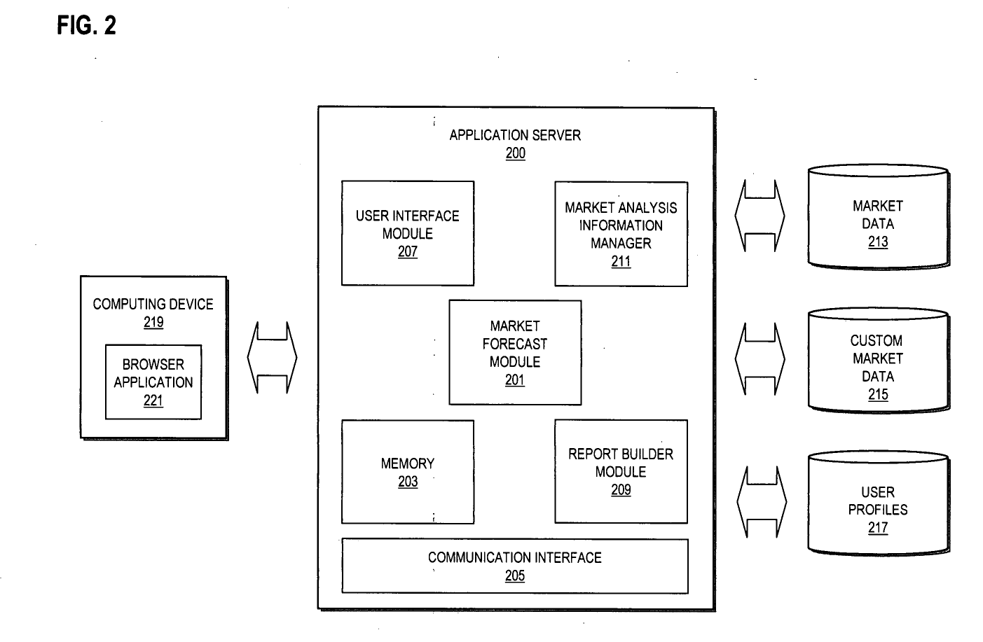

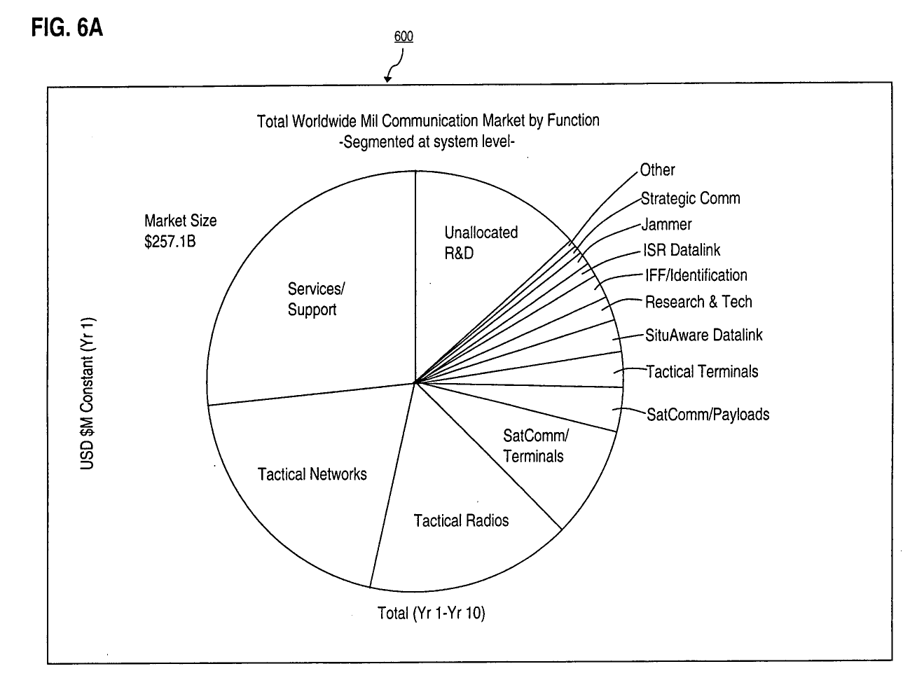

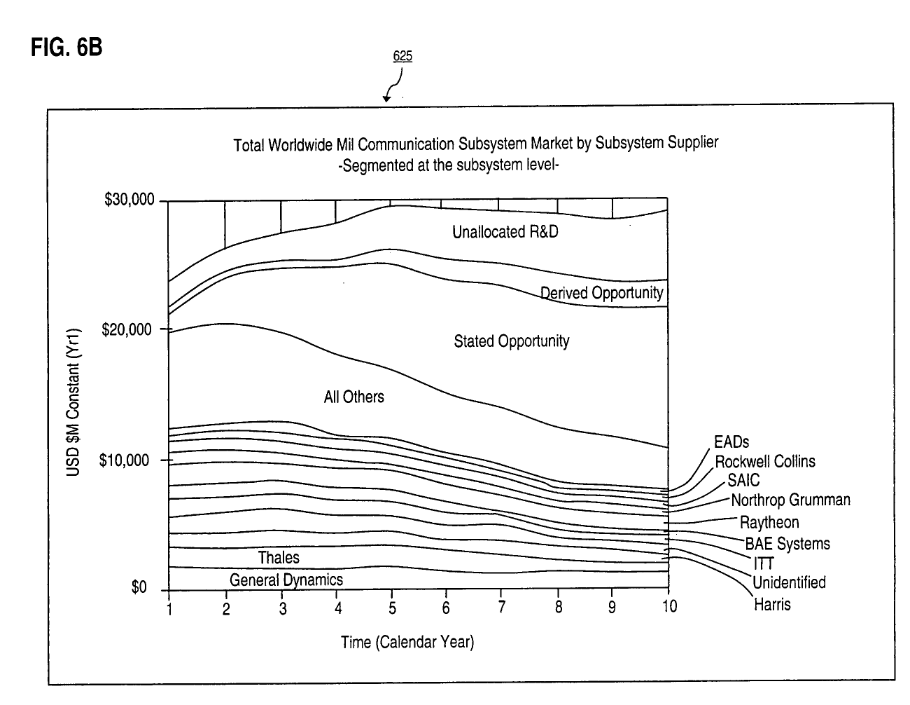

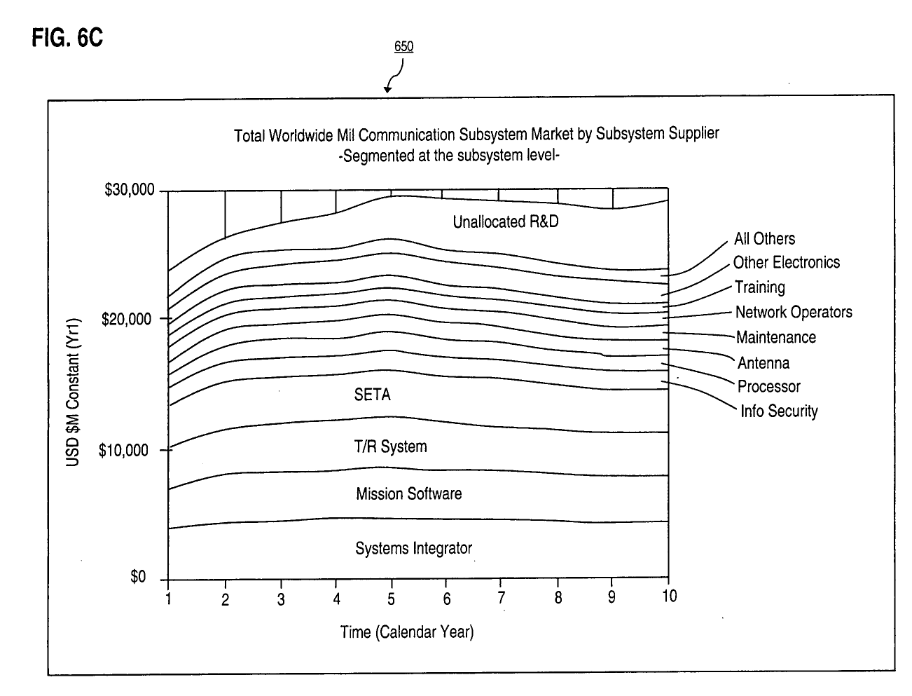

FIG. 2 is a diagram of an application server capable of providing a segmented market forecast, according to an exemplary embodiment. In the example of FIG. 2, application server 200 may comprise computing hardware (such as described with respect to FIG. 6), as well as include: market forecast module 201, memory 203, communication interface 205, user interface module 207, report builder module 209, and market analysis information manager module 211. In turn, application server 200 can be in communication with one or more databases, e.g., databases 213, 215 and 217, including market analysis information, customized market analysis information, and user profile information, respectively. Application server 200 may also communicate with one or more client devices, e.g., a computing device 219, via, for example, a browser application 221. It is contemplated that application server 200 may embody many forms and include multiple and/or alternative components. For example, it is contemplated that the one or more modules of application server 200 may be combined, located in separate structures, and/or separate physical locations. In other words, a specific topology is not critical to embodiments of application server 200 or system 100.

Market forecast module 201 receives user input relating to customizable market definitions and market views to output market analysis information, wherein the market analysis information is input to report builder module 209 for developing and/or modifying a market analysis report. In essence, market forecast module 201 provides an all-purpose control mechanism for acquiring appropriate market analysis information to build corresponding market reports in response to one or more user commands. As such, market forecast module can invoke each of the other components of application server 200 as necessary to perform the various functions provided by application server 200. According to various other embodiments, the one or more components of application server 200 may operate autonomously with respect to market forecast module 201.

In this manner, user commands are acquired from user interface module 207 executing a GUI application configured to provide a user (at, for instance, computing device 219) with one or more menus of options relating to market definition and market view parameters that, in turn, correspond to one or more product/service markets to be analyzed. This assists novice users who lack programming knowledge in performing queries and analyzing results related to the market analysis information of databases 213 and/or 215. In one embodiment, user interfaces are presented in a window(s) of a conventional browser application 221 executed on computing device 219. Alternatively or additionally, user interfaces may be generated and presented in a window(s) controlled by computing device 219. In this manner, users at computing device 219 may input commands to specify a market definition and/or market view related to a product/service market, as well as to develop and/or modify market analysis reports. As such, the GUI may comprise a central page of both textual and graphical information, as well as various interactive control widgets, through which users may access and interact with the market analysis information of databases 213 and/or 215. Accordingly, users may utilize the GUI application to obtain displays of information in the form of tables, graphs, reports, pivots, web pages, and the like to efficiently extract meaningful data via the GUI application. Moreover, the GUI enables users to seamlessly switch between displays, as well as sort and filter the market analysis information through the menu of options. Furthermore, user interface module 207 may be configured to send signals to and receive signals from communication interface 205, as well as one or more of the other components of application server 200.

Communication interface 205 may be configured to receive signals from computing device 219, including responses to menus of options included within a GUI application. Additionally, communication interface 205 is configured to retrieve market analysis information (in response to requests from market forecast module 201) for developing and/or modifying a customized market analysis report, wherein the market analysis information can be retrieved from one or more market data repositories, e.g., databases 213 and/or 215. In particular embodiments, communication interface 205 can be configured to transmit data, e.g., GUI information and/or market analysis report information, to computing device 219. In other instances, communication interface 205 may be configured to receive data, e.g., market analysis information or customized market analysis information, from computing device 219 and provide this information to market forecast module 201 and/or databases 213 and 215.

Market analysis information manager module 211 organizes the market analysis information in databases 213, 215, and/or memory 203 for speed and efficiency purposes, i.e., for selection by market forecast module 201. As previously mentioned, this organization may be in the form of a hierarchical format, such as a rational table, object class, data cloud, or any other suitable format.

Report builder module 209 is configured to implement various content creation tools, such as a charting or graphing tool, for developing and modifying a customizable market analysis report. These content creation tools enable users to represent the market analysis information in readily understandable formats, i.e., as graphical representations summarizing data, for instance. Exemplary charts are illustrated in FIGS. 6A-6C. In particular embodiments, report builder module 209 edits new and/or existing market analysis reports based on user input, wherein the user input relates to modified market definition properties, such as a market geography setting, and/or market view properties, such as a granularity setting. Generated reports may be structured in any suitable format, e.g., extensible markup language (XML) schema, binary format, proprietary format, etc. As such, market forecast module 201 may also be configured to take as input, the various output from report builder module 209 and, in certain instances, user interface module 207.

While not illustrated, application server 200 may also include a verification module for authenticating users to the market research and forecast service. That is, the verification module may verify user log on data (e.g., credential information, such as a username and password) against an authorized user list including corresponding information in, for example, memory 203, user profiles database 217, or other repository of system 100 to provide selective access to the functions of application server 200. In various embodiments, information stored to a user profile may be utilized by the verification module to permit or restrict access to select market analysis information. For example, a user may be restricted to only obtaining market analysis information and customized market analysis reports for a select number of product and/or service markets. According to other embodiments, the verification module may utilize user profile information to permit or to restrict user access to the ability to acquire (e.g., download), augment (e.g., upload), customize, and/or modify the market analysis information input to market forecast module 201. In other instances, the verification module may utilize one or more parameters within a user profile to enable users to store a customized market analysis dataset to database 215 or port previously stored customized market analysis datasets to memory 203 and/or market forecast module 201 upon successful user authentication.

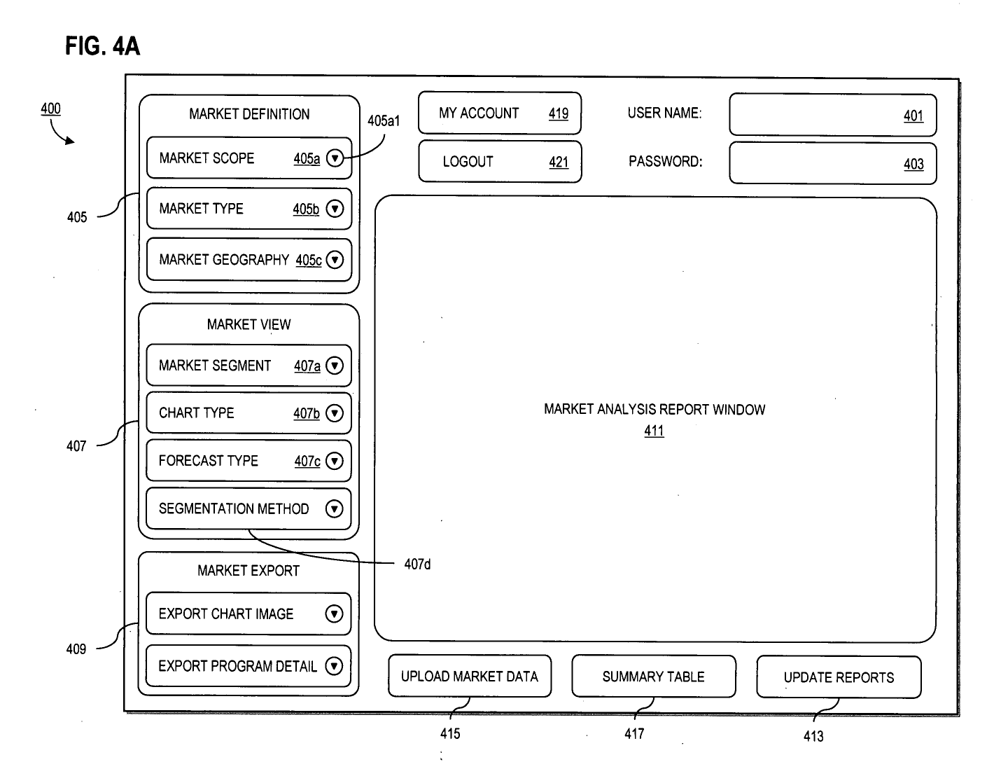

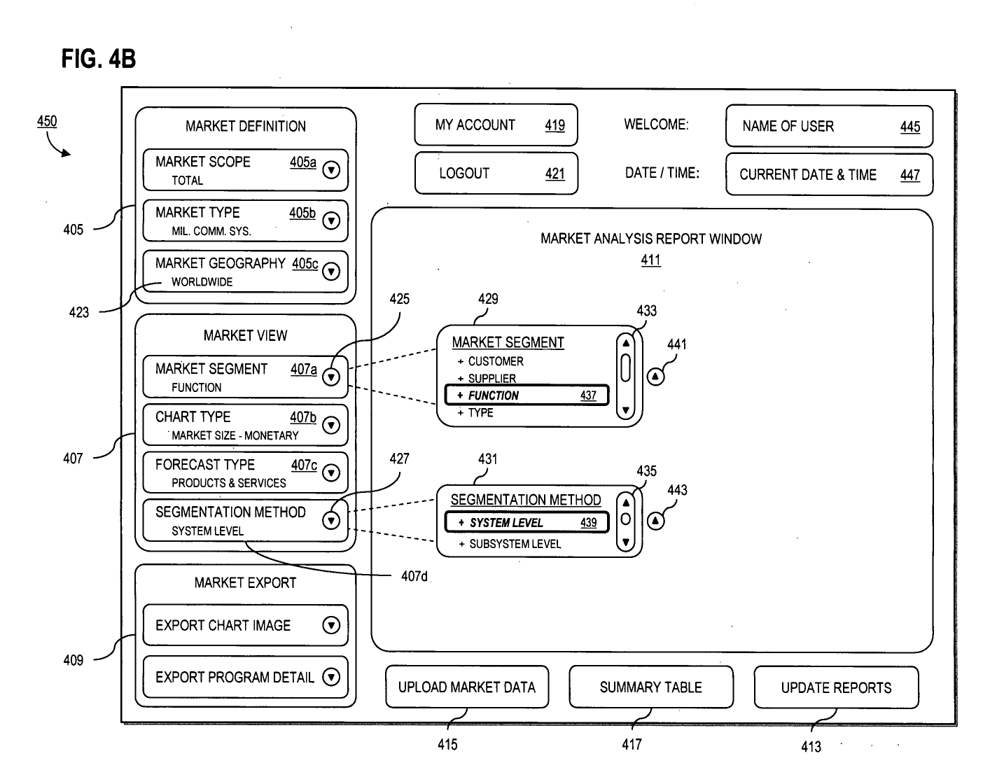

FIG. 3A is a flowchart of a process for generating a segmented market forecast, according to an exemplary embodiment. This process is described with respect to an exemplary user interface of FIG. 4A. Initially, market analysis information is generated based on data collected, processed, and analyzed from various periodicals or other informational sources, such as conference proceedings, contract awards, governmental documents, industry reports, press releases, primary (or field) research, and/or trade publications, as well as any other suitable medium, such as third-party market research reports. Additionally or alternatively, market analysis information may include user augmented, customized, and/or modified datasets as previously mentioned, Accordingly, the generation of the market analysis information may be implemented through a manual process (e.g., by way of one or more market analysts 111) and/or an automated process (e.g., by way of one or more “expert” systems). This information can be hierarchically maintained, i.e., structured, in one or more repositories, such as databases 213 and/or 215. It is noted that any suitable data analysis/mining/synthesis technique(s) may be implemented for the process of populating databases 213 and/or 215. Accordingly, the aforementioned routines may be performed “off-line” as part of a service offered by a service provider, such as a provider of the market research and forecast service of system 100. In other instances, the aforementioned routines may be performed by the users, wherein user provided market analysis information is made available to application server 200, such as by an uploading process.

In this manner, a user of the market research and forecast service accesses, e.g., logs on to, application server 200 via computing device 219, which is capable of processing and transmitting data over a network (e.g., network 105), per step 301. That is, the user may interact with an input interface of computing device 219 to activate software resident on the device, e.g., browser application 221. The software may then establish one or more connections to application server 200, via network 105, through, for example, an internet protocol (IP) based connection. Consequently, the user may be required to provide certain credentials, such as a username and password, to application server 200 via, for instance, a GUI of browser application 221. As seen in FIG. 4A, a GUI 400 is provided, wherein one or more input fields (e.g., fields 401 and 403) are included for conveying a username and password to application server 200; however, it is contemplated that additional or other credential information may be utilized. According to one embodiment, “log on” procedures may be facilitated by the aforementioned verification module of application server 200, which may access (via communication interface 205) information within a profile of the user for such purposes. The user profile information may also be temporarily stored to memory 203 during the pendency of the session of the user. Further, it is contemplated that other authentication/authorization methods may be implemented, such as authenticating a user based on an IP address and digital signature of an accessing computing device 219, etc.

Once the user is successfully authenticated to application server 200, user interface module 207 may utilize information (e.g., one or more user defined policies or parameters) within the profile of the user to customize the presentation of, for instance, the display of the GUI of browser application 221. For example, input fields 401 and 403 may be dynamically modified to display fields 445 (e.g., a “WELCOME USERNAME” field) and 447 (e.g., a “CURRENT DATE & TIME” field) as illustrated in FIG. 4B. Accordingly, browser application 221 may present the user with an individualized plurality of options for viewing market research and forecast information concerning a target market/industry. Namely, browser application 221 presents display information acquired from user interface module 207 to the user via a display interface of computing device 219. The plurality of options may correspond to parameters, such as one or more market definition inputs (e.g., market scope, market type, and/or market geography) and/or one or more market view inputs (e.g., market segment, analysis methodology, forecasting methodology, and/or segmentation methodology). Further, based on the information within the user profile, the functionality of the aforementioned market definition and/or market view inputs may be selectively expanded or restricted. For example, a first user may be limited to a “total” market scope for the domestic military communication systems market, while a second user may be provided full access rights to, for instance, the entire aerospace and military industries.

As seen in FIG. 4A, GUI 400 provides a plurality of “drop-down” menus to enable users to specify a particular market definition and market view to align the market research and forecast service of system 100 to the market boundaries and market conceptualizations of individual users. For example, a first plurality 405 of drop-down menus (i.e., market scope 405a, market type 405b, and market geography 405c menus of options) correspond to market definition inputs, while a second plurality 407 of drop-down menus (i.e., market segment 407a, chart type 407b, forecast type 407c, and segmentation method 407d menus of options) correspond to market view inputs. These menus of options may include selectable icons (e.g., icon 405a1) for expanding the menus of options and to enable users to select (or otherwise interact) with the options therein. This will be more readily understood as the same is described in conjunction with FIGS. 3B and 4B. Table 1 (below) briefly summarizes the function of the market definition and market view menus of options. It is contemplated, however, that additional or alternative sets of options may be provided or otherwise distributed.

TABLE 1

| | Menu of Options | Function |
|---|---|---|
| Market | Market Scope 405a | Enables users to define: |
| Definition | | one or more target customers, e.g., |
| Menu 405 | | the United States Navy; or |
| | | one or more target suppliers, e.g., |
| | | General Dynamics; |
| | Market Type 405b | Enables users to define: |
| | | one or more target industries, e.g., |
| | | the military industry; and |
| | | one or more target markets, e.g., |
| | | the communication systems market |
| | Market Geography | Enables users to define: |
| | 405c | the geographic boundaries of the |
| | | target industry and market, e.g., the |
| | | worldwide, both foreign and |
| | | domestic, i.e., geographically |
| | | boundless, market |
| Market | Market Segment | Enables users to view the market in |
| View 407 | 407a | terms of: |
| | | product/service suppliers; |
| | | product/service customers; |
| | | product/service function (e.g., |
| | | strategic communicators); or |
| | | product/service type (e.g., |
| | | transmitters) |
| | Chart Type 407b | Enables users to view the market in |
| | | terms of: |
| | | one or more financial schemas, |
| | | e.g., annual forecasted revenue |
| | Forecast Type 407c | Enables users to view the market in |
| | | terms of: |
| | | products; and/or |
| | | services |
| | Segmentation | Enables users to view the market at the: |
| | Method 407d | product/service system level; or |
| | | product/service subsystem level |

It is noted that the “selection” of one option within a first menu of options may dynamically modify the availability of other options in other menus of options. For instance, if a user selects to segment the market at the product subsystem level within the segment method 407d menu of options, then the market segment 407a menu of options may be confined to viewing the market based on sub-product customers, sub-product suppliers, sub-product functions, sub-product types, etc. Namely, options corresponding to the product system level, the service system level, and the service subsystem level may be made unavailable. Nevertheless, by manipulating the pluralities of menus of options 405 and 407, a user may seamlessly formulate a query for obtaining select market analysis information from databases 213 and/or 215, as well as provide commands for market analysis report presentation. A third plurality 409 of drop-down menus may be provided to correspond to market exporting functions. That is, selection of the options provided by plurality 409 enables users to export market analysis report images or underlying market analysis data utilized to generate the market analysis reports.

Referring back to FIG. 3A, at step 303, application server 200 receives a query from computing device 219 based on the user selecting one or more options provided within the pluralities of menus of options 405, 407 and/or 409. Based on the received query, market forecast module 201, via communication interface 205, retrieves corresponding market analysis information from databases 213 and/or 215, per step 305. The process of retrieving this market analysis information may be further based on information (e.g., one or more user-defined parameters or policies) within a user profile. In this manner, market forecast module 201 may be provided with database organizational information from market analysis information manager 211, such that market forecast module 201 may efficiently obtain the corresponding market analysis information from databases 213 and/or 215. The retrieved market analysis information may be provided to report building module 209, along with corresponding user-defined report building options (as may be defined by the selection of the options within the pluralities of menus 405, 407, and/or 409, and/or based on information within a user profile), for generating a market analysis report. After generating the market analysis report, user interface module 207 may provide, via communication interface 205, display information to browser application 221. At step 307, browser application 221 presents the market analysis information to the user in the form of, for example, a market analysis report, e.g., as a table, graph, chart, pivot, text, or combination thereof. As seen in FIG. 4A, a market analysis report window 411 is provided for this purpose.

According to one embodiment, subsequent interaction with one or more options, such as the options within the market definition menus 405, market view menus 407, and/or market export menus 409, dynamically updates the display of window 411 through the process of FIG. 3A. According to other embodiments, a selectable icon or button 413 may be provided, such that a market report will not be updated until icon 413 is selected. Additionally or alternatively, icon 413 may be utilized to update the underlying data of a displayed market analysis report, such as for the purpose of including user-customized market analysis data recently stored in database 215, but not included within the market analysis report. In this manner, a selectable icon 415 may be provided to enable users to upload market analysis information to application server 200 and/or database 215. As such, selection of icon 413 may retransmit the query of step 303 to application server 200 to ensure the most up-to-date information is presented. Further, a selectable icon 417 may be provided for toggling window 411 between a generated market analysis report and a summary table presenting the underlying data utilized to generate the market analysis report. Selectable icon 419 enables users to access and/or modify information within a corresponding user profile, while selectable icon 421 enables users to “logout” of a market research and forecast session.

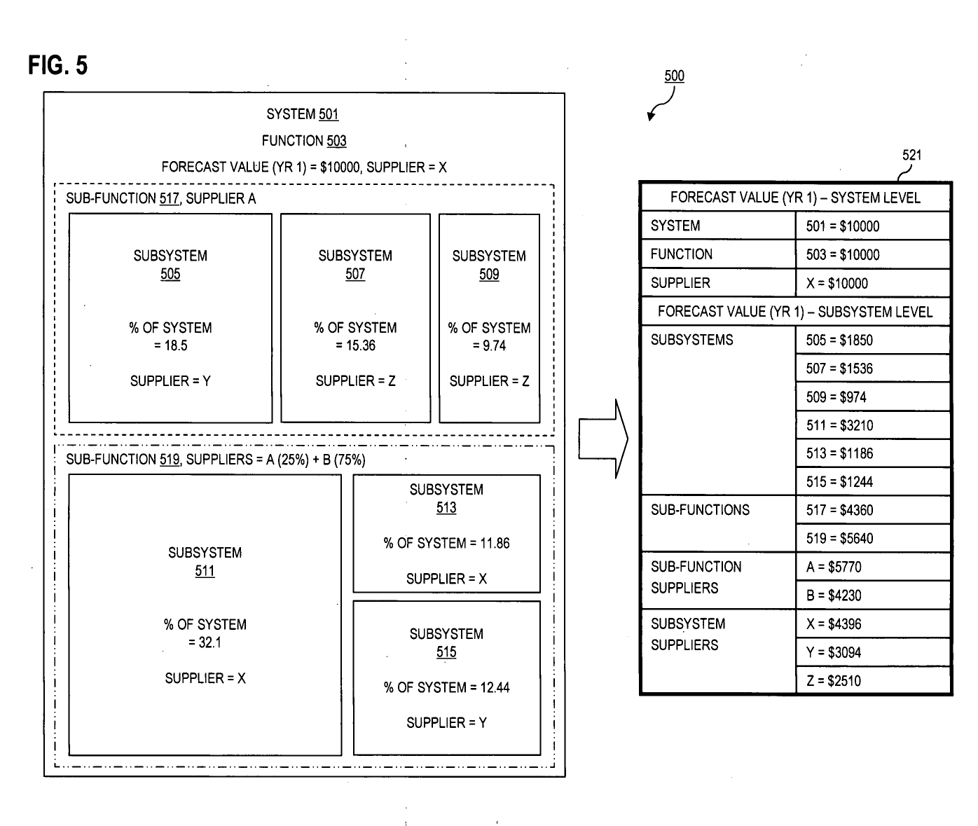

FIG. 3B is a flowchart of a process for generating and presenting segmented market analysis information, according to an exemplary embodiment. This process is described with respect to an exemplary user interface 450 of FIG. 4B and an exemplary diagram 500 of FIG. 5. At step 331, application server 200, via communication interface 205, receives a market analysis query from computing device 219 based on one or more input(s) to browser application 221 by an authenticated user. This query may correspond to the selection of one or more options within the pluralities of menus of options, e.g., market definition menus 405, market view menus 407, and/or market export menus 409. Further, the query may also correspond to one or more user customized datasets based on information stored to a profile of the user. Accordingly, the query may include one or more parameters related to the selection of market segmentation and/or segmentation methodology options.

Referring to FIG. 4B, a user may define their target market as the total worldwide military communication systems market via interaction with menus 405a-405c. In order to facilitate interface usability, a descriptive selection title (e.g., title 423) may be provided for one or more of the menus (e.g., menus 405a-405c and/or 407a-407c). Similarly, the user may select to forecast the monetary value of the defined market based on both products and services utilizing menus 407b and 407c, respectively.

To segment the market, the user may interact with menus 407a and/or 407b. In the depicted embodiment, menus 407a and 407b include icons 425 and 427, respectively, for expanding the corresponding drop-down menus. An expanded market segment menu 429 and an expanded segmentation method menu 431 include one or more selectable options corresponding to the functions previously described in Table 1. Accordingly, users may navigate to particular options via, for instance, an input interface of computing device 219, such as a cursor control. One or more fixed focus states (e.g., borders 437 and 439) and/or distinctive magnification features, e.g., color, brightness, bolding, font type, text size, etc., may be used to convey a “currently” navigated position or parameter capable of being “currently” selected. According to one embodiment, after selecting one or more options, expanded menus 429 and 431 may dynamically revert to menus 425 and 427, respectively. In other instances, selectable icons 441 and 443 may be provided for collapsing expanded menus 429 and 431, respectively. It is noted that the various other menus (e.g., menus 405a-405c, 407b, 407c, and 409) may be interacted with in a similar accord. As previously mentioned, manipulating the pluralities of menus of options (e.g., 405, 407, and 409) seamlessly formulates a query for obtaining select market analysis information from databases 213 and/or 215, wherein the query is transmitted to application server 200 for retrieving this information.

Referring back to FIG. 3B, based on the received query, application server 200 (e.g., market forecast module 201) retrieves corresponding market analysis information from database 213 and/or 215 via communication interface 205, per step 333. In particular implementations, application server 200 retrieves system level market analysis information, wherein subsystem level market analysis information is derived therefrom, or vice versa. According to one embodiment, this retrieved market analysis information may be further complemented by augmented data uploaded by the user via interaction with, for instance, selectable icon 415 of FIG. 4B. The augmented data may be received before, after, or in conjunction with the query. In any case, an instance of the retrieved and/or received market analysis information may be stored to memory 203 during the pendency of a user session.

At step 335, market forecast module 201, based on one or more parameters of the user defined query, parses the retrieved system level market analysis information and generates subsystem level market analysis information based on the parsed data. Namely, market forecast module 201 may identify one or more sub-product/sub-service entries to segregate the system level data according to those entries. Utilizing one or more sub-product/sub-service values, the aggregated values of the system level data may be granulated, i.e., attributed to the sub-product/sub-service entries and/or other sub-parameters of the market analysis information, such as one or more sub-functions, sub-types, etc. In one embodiment, this process may be performed by, alternatively or in addition to, a back-end server (not illustrated) to reduce the processing load on application server 200. The creation of exemplary subsystem level market analysis information is further shown in FIG. 5.

FIG. 5 is a diagram illustrating the generation of segmented market analysis information, according to an exemplary embodiment. For the purposes of explanation, the system level data includes system 501, e.g., a tactical radio, serving function 503, e.g., strategic communications, with a forecasted value in year 1 of $10,000. This forecasted value may have been assigned by the aforementioned analysts 111, the “expert” system of system 100, and/or a user based on information provided within one or more of the aforementioned information sources or through primary market research. System 501 is supplied by supplier “X.” Accordingly, the system level market analysis information credits 100% of the program to supplier “X” and function 503. The system level data, however, also includes an indication that system 501 includes one or more subsystems (e.g., subsystems 505-515) serving one or more sub-functions (e.g., sub-functions 517 and 519). For example, sub-function 517 may correspond to receiving communications, wherein subsystems 505-509 are including as components of a radio receiver. Sub-function 519 may correspond to transmitting communications, wherein subsystems 511-515 are included as components of a radio transmitter. Accordingly, the sub-functions and/or subsystems may be supplied by one or more suppliers (e.g., suppliers “X,” “Y,” and “Z”), as is shown. This subsystem information may include (for each subsystem, sub-function, and supplier of the subsystem/sub-function) a percentage value representing a percentage of the system level forecasted value. This percentage value may also have been provided by the analysts 111, the “expert” system, or the user. In particular implementations, the percentage value is generated based on predetermined criteria, such as cost, complexity, necessity, market definition/forces/segment, technological sophistication, and/or industry recognition. Utilizing this information, the system level data may be parsed according to subsystem, sub-function, and subsystem/sub-function supplier to generate corresponding subsystem level market analysis information, as is shown in box 521.

The granulated subsystem level market analysis information reveals that supplier “X” only really contributes, for instance, $4,396 to system 501, wherein the remaining forecasted value of system 501 is provided by suppliers “Y” (e.g., $3,094) and “Z” (e.g., $2510). At a sub-function level, supplier A (providing the radio receiver and a portion of the radio transmitter) and supplier B (providing a portion of the radio transmitter) are attributed the credit, whereas at the system level supplier “X” is attributed the credit. Further, the system level data may also be granulated at the sub-function (e.g., 517 and 519) and subsystem (e.g., 505-515) levels, as is also shown in box 521. In this manner, the aggregated values of the system level market analysis information may be granulated into subsystem level market analysis information, which provides businesses a deeper understanding of a market.

Referring back to FIG. 3B, the system level market analysis information and/or the subsystem level market analysis information may be provided to report building module 209, along with corresponding user-defined report building options, for presenting the information to the user, per step 337. Namely, report building module 209 generates a market analysis report, wherein user interface module 207 provides display information to browser application 221, via communication interface 205, for presentation. Accordingly, browser application 221 presents the market analysis information to the user in the form of, for example, a market analysis report, e.g., as a table, graph, chart, pivot, text, or combination thereof, which can be displayed in market analysis report window 411 of FIG. 4B. Exemplary segmented market analysis reports are illustrated in FIGS. 6A-6C.

FIGS. 6A-6C are diagrams of segmented market analysis reports, according to various exemplary embodiments. As seen in FIG. 6A, report 600 provides exemplary market analysis information (e.g., a monetary market size forecasted over a predetermined time period, i.e., from a first year to a tenth year) for the total worldwide military communication systems market based on one or more functions performed by the market. This information is segmented at the system level. In FIG. 6B, report 625 corresponds to, for example, the total worldwide military communication subsystems market further segmented to correspond to the subsystem suppliers of the subsystem components. Accordingly, report 625 relates to the total program revenue for the various subsystem component suppliers forecasted over a predetermined time internal, i.e., from a first year to a tenth year. FIG. 6C illustrates report 650 corresponding to the total worldwide military communication subsystems market further segmented to correspond to the subsystem components as a function of subsystem component type. Accordingly, report 650 relates to the total program revenue for the communication subsystem component types forecasted over a predetermined time internal, i.e., from a first year to a tenth year. As such, the various user-customizable market analysis reports provide users various perspectives and insights to a industry/market, which may be used for purposes, such as business development, strategic planning, competitive intelligence, merger and acquisition analysis, teaming analysis, and executive support, as well as many other suitable business related purposes. It is noted that reports of FIGS. 6A-6C are merely illustrative as a customizable market analysis report provided via system 100 may correspond to any of the aforementioned industries/markets, and further may be customized according to various user-customized market definitions and market views, as well as user augmented, customized, or modified datasets. Moreover, the information provided therein may correspond to any financial datum and may be segmented at any level of granularity, such as segments corresponding to market forces, technological/financial composition, system functions, etc.

The above described processes relating to providing segmented market forecasts may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

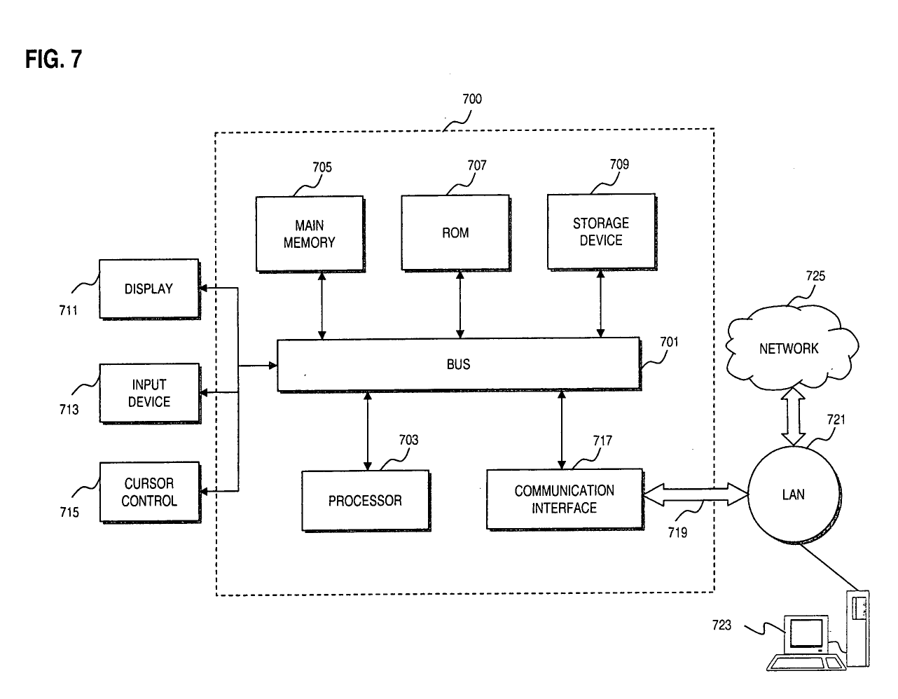

FIG. 7 illustrates a computer system 700 upon which an exemplary embodiment can be implemented. For example, the processes described herein can be implemented using the computer system 700. The computer system 700 includes a bus 701 or other communication mechanism for communicating information and a processor 703 coupled to the bus 701 for processing information. The computer system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for controlling cursor movement on the display 711.

According to an embodiment, the processes described herein are performed by the computer system 700, in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the exemplary embodiment. Thus, exemplary embodiments are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for Ethernet™ or an Asynchronous Transfer Model (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc. Although a single communication interface 717 is depicted in FIG. 7, multiple communication interfaces can also be employed.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an exemplary embodiment through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the various exemplary embodiments may initially be borne on a magnetic disk of a remote computer. In such a scenario, the remote computer loads the instructions into main memory and sends the instructions over a telephone line using a modem. A modem of a local computer system receives the data on the telephone line and uses an infrared, Bluetooth, or other wireless transmitter to convert the data to an infrared, Bluetooth, or other wireless signal and transmit the infrared, Bluetooth, or other wireless signal to a portable computing device, such as a personal digital assistant (PDA) or a laptop. An infrared, Bluetooth, or other wireless detector on the portable computing device receives the information and instructions borne by the infrared, Bluetooth, or other wireless signal and places the data on a bus. The bus conveys the data to main memory, from which a processor retrieves and executes the instructions. The instructions received by main memory can optionally be stored on storage device either before or after execution by processor.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements. Further, the use of words and phrases, such as “e.g.,” “including,” “for example,” “for instance,” “such as,” and “like,” are not intended to define any preceding terms or phrases, but merely set forth particular examples out of possibly many.

What is claimed is:

1. A method comprising:
receiving a query, via a graphical user interface, from a user;
retrieving market analysis information from a data repository in response to the query, wherein the market analysis information includes forecast data about a product and associated components in relation to a plurality of market segments, the data being hierarchically arranged with respect to the components; and
presenting, via the graphical user interface, the market analysis information to the user.

2. A method according to claim 1, further comprising:
prompting the user with a plurality of options for viewing the market analysis information, wherein the options include a charting tool.

3. A method according to claim 1, wherein the graphical user interface includes a browser application.

4. A method according to claim 1, wherein the market analysis information is generated based on a plurality of information sources that are analyzed according to a predetermined criteria.

5. A method according to claim 4, wherein the information sources include a periodical, an industry report, a governmental document, a press release, a trade publication, or a combination thereof.

6. A method according to claim 4, wherein the information sources span a predetermined time interval.

7. A method according to claim 4, wherein the predetermined criteria include estimated product delivery, forecasted revenue, market trend, aging inventory, emerging technology, buying pattern, or a combination thereof.

8. A method according to claim 4, wherein the market analysis information is correlated to documentation, analyst assessment, or a combination thereof.

9. A method according to claim 1, further comprising:
outputting a report based on the market analysis information for assessment of the market segments.

10. An apparatus comprising:
a processor configured to receive a query, via a graphical user interface, from a user; and
a communication interface configured to retrieve market analysis information from a data repository in response to the query, wherein the market analysis information includes forecast data about a product and associated components in relation to a plurality of market segments, the data being hierarchically arranged with respect to the components,
wherein the graphical user interface is further configured to present the market analysis information to the user.

11. An apparatus according to claim 10, wherein the graphical user interface is further configured to prompt the user with a plurality of options for viewing the market analysis information, the options including a charting tool.

12. An apparatus according to claim 10, wherein the graphical user interface includes a browser application.

13. An apparatus according to claim 10, wherein the market analysis information is generated based on a plurality of information sources that are analyzed according to a predetermined criteria.

14. An apparatus according to claim 13, wherein the information sources include a periodical, an industry report, a governmental document, a press release, a trade publication, or a combination thereof.

15. An apparatus according to claim 13, wherein the information sources span a predetermined time interval.

16. An apparatus according to claim 13, wherein the criteria include estimated product delivery, forecasted revenue, market trend, aging inventory, emerging technology, buying pattern, or a combination thereof.

17. An apparatus according to claim 13, wherein the market analysis information is correlated to documentation, analyst assessment, or a combination thereof.

18. An apparatus according to claim 10, wherein the graphical user interface is further configured to output a report based on the market analysis information for assessment of the market segments.

19. A system comprising:
a server configured to receive a query, via a browser application, from a user; and
a data repository configured to store market analysis information, wherein the market analysis information is accessed by the server in response to the query, the market analysis information including forecast data about a product and associated components in relation to a plurality of market segments, the forecast data being hierarchically arranged with respect to the components,
wherein the server is further configured to present the market analysis information to the user via the browser application.

20. A system according to claim 19, wherein the market analysis information is generated based on a plurality of information sources that are analyzed according to a predetermined criteria that include estimated product delivery, forecasted revenue, market trend, aging inventory, emerging technology, buying pattern, or a combination thereof, the information sources including a periodical, an industry report, a governmental document, a press release, a trade publication, or a combination thereof.

21. A method according to claim 1, further comprising:
receiving market analysis information from the user; and
presenting, via the graphical user interface, the user-provided market analysis information or a correlated combination of the market analysis information and the user-provided market analysis information.

22. A method according to claim 21, further comprising:
providing the market analysis information to the user,
wherein the user-provided market analysis information corresponds to a user modified version of the market analysis information.

23. A method comprising:
receiving a query, via a graphical user interface, from a user;
retrieving system level market analysis information from a data repository in response to the query, wherein the system level market analysis information includes forecast data about a system and associated subsystems, the associated subsystem data includes subsystem values corresponding to a portion of a value of the system;
generating subsystem level market analysis information based on the value of the system and the associated subsystem values; and
presenting, via the graphical user interface, the subsystem level market analysis information to the user.

24. A method according to claim 23, wherein the subsystem values are assigned to the associated subsystems based on the market segment of the system and one or more predetermined criteria including cost, complexity, necessity, technological sophistication, and industry recognition.

25. A method according to claim 23, further comprising:
providing the system level market analysis information to the user;
receiving modified system level market analysis information from the user; and
generating the subsystem level market analysis information based on the modified system level market analysis information.
